(19) United States
(12) Patent Application Publication
(10) Pub. No.: US 2026/0280631 A1
(43) Pub. Date: Sep. 17, 2026

(54) DYNAMIC BEAMS FOR A CUSTOMER PREMISES EQUIPMENT

(71) Applicant: QUALCOMM Incorporated, San Diego, CA (US)

(72) Inventors: Jun ZHU, San Diego, CA (US); Yi HUANG, San Jose, CA (US); Rahul MALIK, San Diego, CA (US)

(21) Appl. No.: 19/076,167

(22) Filed: Mar. 11, 2025

(51) Int. Cl. H04B 7/06; H04L 25/02; H04W 16/28

(52) U.S. Cl. CPC H04B 7/0617; H04B 7/0634; H04L 25/0212; H04W 16/28

(57) ABSTRACT

Various aspects of the present disclosure generally relate to wireless communication. In some aspects, a customer premises equipment (CPE) may receive channel impulse response (CIR) measurements associated with a set of user equipment (UE) beams. The CPE may generate a beam correlation matrix based at least in part on the CIR measurements. The CPE may calculate a beam distribution vector based at least in part on the beam correlation matrix. The CPE may generate dynamic beams for the CPE based at least in part on the beam distribution vector, wherein the dynamic beams are associated with one or more beamforming weights. The CPE may communicate with a network node based at least in part on the dynamic beams. Numerous other aspects are described.

### FIELD OF THE DISCLOSURE

Aspects of the present disclosure generally relate to wireless communication, and specifically relate to techniques, apparatuses, and methods associated with dynamic beams for a customer premises equipment.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at a customer premises equipment (CPE) includes one or more memories and one or more processors, the one or more processors, individually or collectively and based at least in part on information stored in the one or more memories, being configured to: receive channel impulse response (CIR) measurements associated with a set of user equipment (UE) beams; generate a beam correlation matrix based at least in part on the CIR measurements; calculate a beam distribution vector based at least in part on the beam correlation matrix; generate dynamic beams for the CPE based at least in part on the beam distribution vector, wherein the dynamic beams are associated with one or more beamforming weights; and communicate with a network node based at least in part on the dynamic beams.

In some implementations, a method of wireless communication performed by a CPE includes receiving, by the CPE, CIR measurements associated with a set of UE beams; generating, by the CPE, a beam correlation matrix based at least in part on the CIR measurements; calculating, by the CPE, a beam distribution vector based at least in part on the beam correlation matrix; generating, by the CPE, dynamic beams for the CPE based at least in part on the beam distribution vector, wherein the dynamic beams are associated with one or more beamforming weights; and communicating, by the CPE, with a network node based at least in part on the dynamic beams.

In some implementations, a non-transitory computer-readable medium storing a set of instructions for wireless communication includes one or more instructions that, when executed by one or more processors of a CPE, cause the CPE to: receive CIR measurements associated with a set of UE beams; generate a beam correlation matrix based at least in part on the CIR measurements; calculate a beam distribution vector based at least in part on the beam correlation matrix; generate dynamic beams for the CPE based at least in part on the beam distribution vector, wherein the dynamic beams are associated with one or more beamforming weights; and communicate with a network node based at least in part on the dynamic beams.

In some implementations, an apparatus for wireless communication includes means for receiving CIR measurements associated with a set of UE beams; means for generating a beam correlation matrix based at least in part on the CIR measurements; means for calculating a beam distribution vector based at least in part on the beam correlation matrix; means for generating dynamic beams for the apparatus based at least in part on the beam distribution vector, wherein the dynamic beams are associated with one or more beamforming weights; and means for communicating with a network node based at least in part on the dynamic beams.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of a customer premises equipment (CPE).

FIG. 4 is a diagram illustrating an example associated with dynamic beams for a CPE.

FIG. 5 is a flowchart illustrating an example process performed, for example, by a CPE.

FIG. 6 is a diagram of an example apparatus for wireless communication.

### DETAILED DESCRIPTION

Dynamic beams are associated with a technique that involves adaptively changing one or more weights used for beamforming. The one or more weights may be changed based at least in part on an instantaneous channel condition to achieve an improved reference signal received power (RSRP). For example, a first set of beamforming weights may achieve a first RSRP. The first set of beamforming weights may be adaptively changed to obtain a second set of beamforming weights based at least in part on the instantaneous channel condition. The second set of beamforming weights may achieve a second RSRP, where the second RSRP may be better than the first RSRP (e.g., the second RSRP may have a higher value than the first RSRP, which may indicate that the second RSRP is associated with a stronger cellular signal as compared to the first RSRP). Dynamic beams may be employed for a user equipment (UE).

A customer premises equipment (CPE) may be associated with static beams. The static beams may be configured offline with, for example, 4 levels and a total of 242 vertical and horizontal pairs. The static beams may not be optimal while matching with 64-element antenna channels. The static beams may also be unable to adapt to multi-cluster channels and environment changes.

Dynamic beams may also be employed for CPEs. However, a dynamic beams design that is applied for UEs may not be suitable for CPEs. For CPEs, a per-element sensing for 64-element beams may not be feasible, which may be due to a single-element gain being relatively small and a channel impulse response (CIR) changing across synchronization signal blocks (SSBs). Although per-element sensing may be available, processing a size-64 channel matrix may be overly complex and power consuming. For CPEs, a 64-element channel estimation may be resource intensive in processing and take an inordinate amount of time, which may prevent a dynamic beams design for CPEs that is directly from channel information.

Various aspects relate generally to dynamic beams. Some aspects more specifically relate to dynamic beams for CPEs. In some examples, a CPE may obtain, from a UE, CIR measurements associated with a set of UE beams. The set of UE beams may include strong UE beams, where the strong UE beams may be beams associated with highest RSRP measurements among a plurality of beams associated with the UE. The CPE may generate a beam correlation matrix based at least in part on the CIR measurements. The beam correlation matrix may be based at least in part on a correlation function and a quantity associated with the set of UE beams. The CPE may calculate a beam distribution vector based at least in part on the beam correlation matrix. For example, the CPE may calculate the beam distribution vector based at least in part on an eigenvalue decomposition or another suitable technique. The CPE may generate dynamic beams based at least in part on the beam distribution vector. The dynamic beams may be associated with one or more beamforming weights. The dynamic beams may allow for the one or more beamforming weights to be adaptively changed based at least in part on an instantaneous channel associated with the CPE. The CPE may communicate with the UE and/or a network node based at least in part on the dynamic beams.

Particular aspects of the subject matter described in this disclosure can be implemented to realize one or more of the following potential advantages. In some examples, by enabling the CPE to generate the dynamic beams based at least in part on the set of UE beams, the described techniques can be used by the CPE to achieve dynamic beams with a reduced amount of processing and in a reduced amount of time. The CPE may utilize the dynamic beams instead of legacy static beams, which may be unable to adapt to multi-cluster channels and environment changes. By utilizing the set of UE beams to obtain the dynamic beams for the CPE, the CPE may avoid per-element sensing for a relatively large number of beams (e.g., per-element sensing for a 64-element beam), which may reduce complexity at the CPE. The CPE may utilize the set of UE beams to obtain the dynamic beams, which may be a different dynamic beams generation scheme than that used by the UE, based at least in part on different challenges specific to the CPE versus the UE. The CPE may utilize the dynamic beams to adaptively change weights used for beamforming based at least in part on an instantaneous channel to achieve an improved RSRP, thereby improving an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

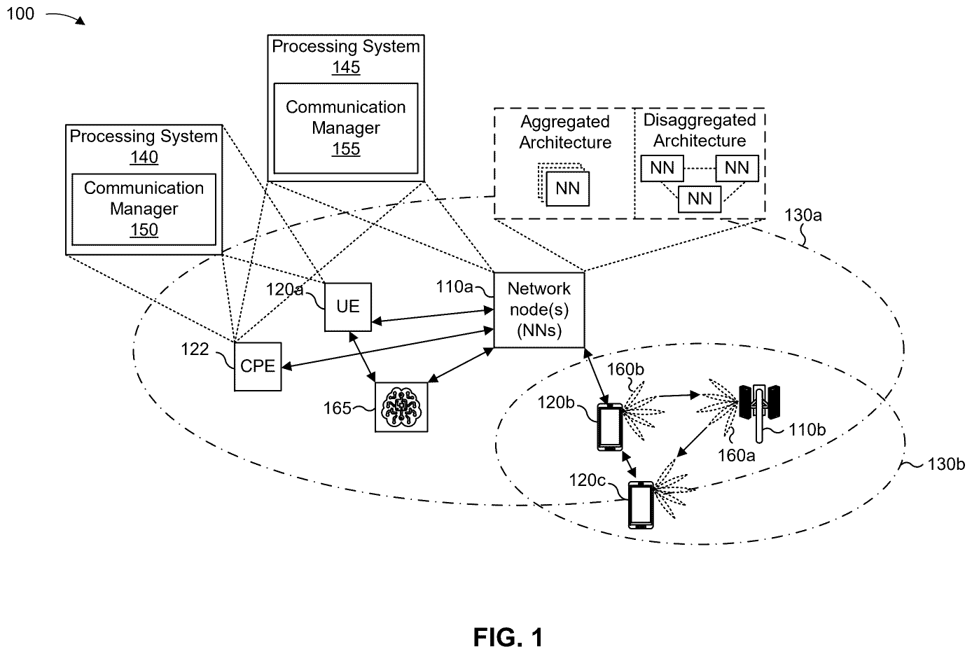

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a CPE (e.g., CPE 122) may include a communication manager 150 or a communication manager 155. As described in more detail elsewhere herein, the communication manager 150 or the communication manager 155 may receive CIR measurements associated with a set of UE beams; generate a beam correlation matrix based at least in part on the CIR measurements; calculate a beam distribution vector based at least in part on the beam correlation matrix; generate dynamic beams for the CPE based at least in part on the beam distribution vector, wherein the dynamic beams are associated with one or more beamforming weights; and communicate with a network node based at least in part on the dynamic beams. Additionally, or alternatively, the communication manager 150 or the communication manager 155 may perform one or more other operations described herein.

As indicated above, FIG. 1 is provided as an example. Other examples may differ from what is described with regard to FIG. 1.

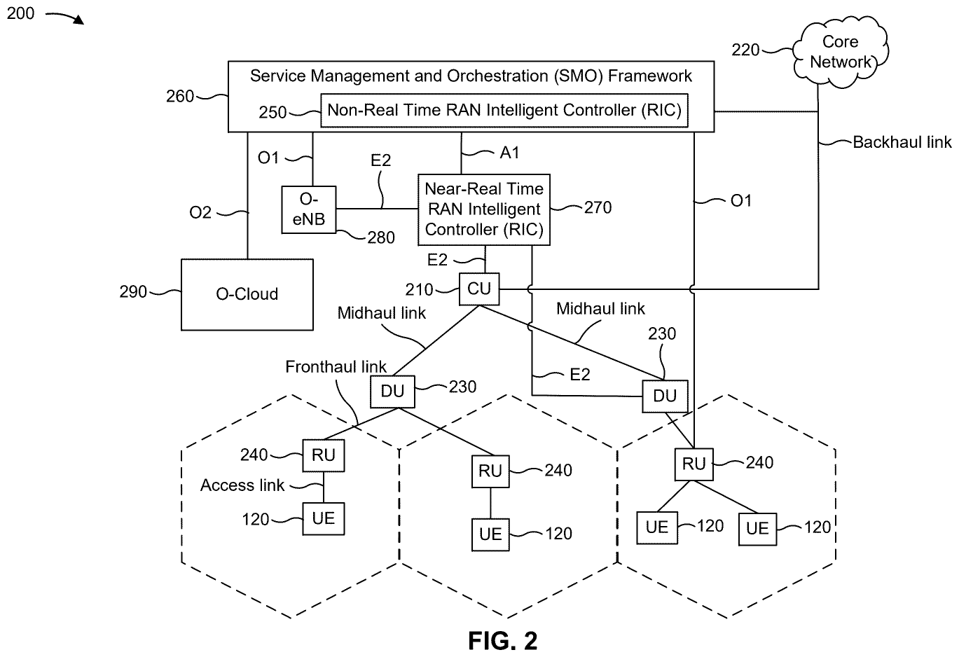

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

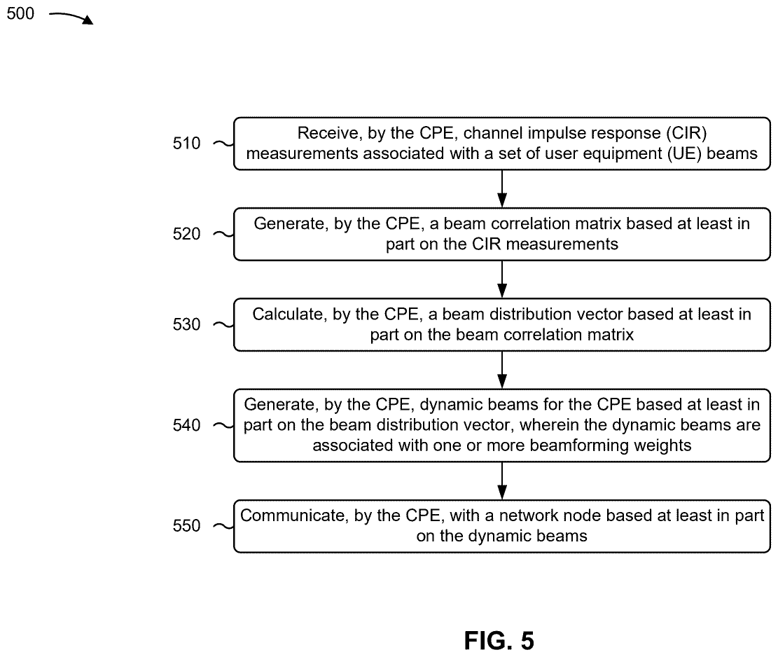

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with dynamic beams for a CPE, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, or other processes as described herein. In some examples, executing instructions may include running the instructions, converting the instructions, compiling the instructions, or interpreting the instructions, among other examples.

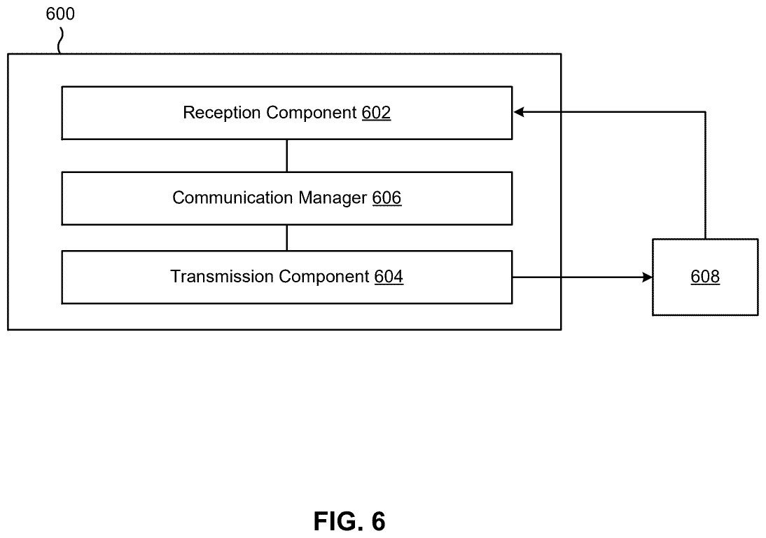

In some aspects, a CPE (e.g., CPE 122) includes means for receiving, by the CPE, CIR measurements associated with a set of UE beams; means for generating, by the CPE, a beam correlation matrix based at least in part on the CIR measurements; means for calculating, by the CPE, a beam distribution vector based at least in part on the beam correlation matrix; means for generating, by the CPE, dynamic beams for the CPE based at least in part on the beam distribution vector, wherein the dynamic beams are associated with one or more beamforming weights; and/or means for communicating, by the CPE, with a network node based at least in part on the dynamic beams. In some aspects, the means for the CPE to perform operations described herein may include, for example, one or more of communication manager 155, processing system 145, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples. In some aspects, the means for the CPE to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

As indicated above, FIG. 2 is provided as an example. Other examples may differ from what is described with regard to FIG. 2.

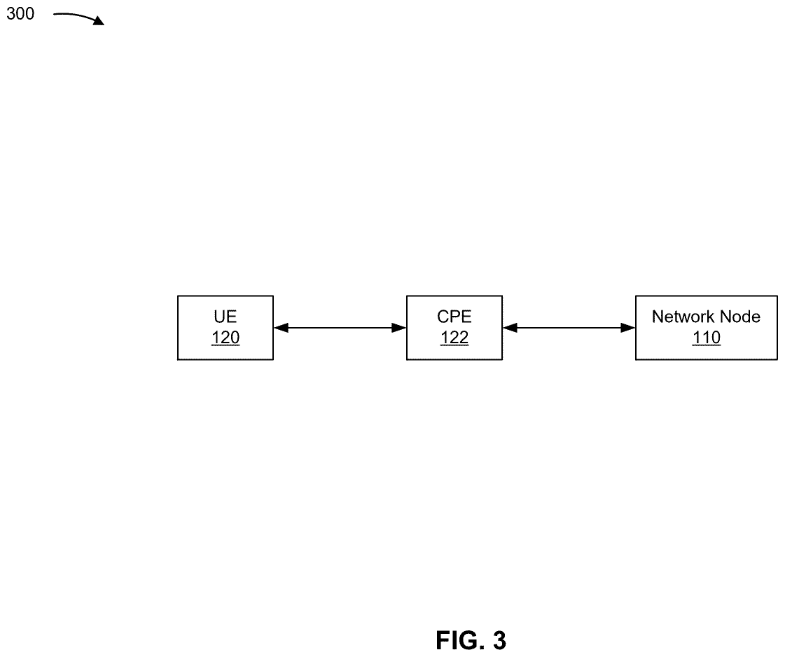

FIG. 3 is a diagram illustrating an example 300 of a CPE.

As shown in FIG. 3, a CPE 122 may be between a UE 120 and a network node 110. The network node 110 may transmit a signal, which may be received by the CPE 122. The CPE 122 may relay the signal to the UE 120. The CPE 122 may perform a secondary relaying of cell phone signals, such as 5G signals. For example, the CPE 122 may receive a 5G signal from the network node 110, and the CPE 122 may relay a Wi-Fi signal or a wired signal to the UE 120. The CPE 122 may be used to relay carrier network signals. The CPE 122 may receive signals from communication operator network nodes and may convert the signals into Wi-Fi or wired signals to connect local devices, such as UEs (e.g., phones, tablets, or computers), to the Internet. Similarly, the UE 120 may transmit a signal, which may be received by the CPE 122. The CPE 122 may relay the signal to the network node 110.

As indicated above, FIG. 3 is provided as an example. Other examples may differ from what is described with regard to FIG. 3.

Dynamic beams are associated with a technique that involves adaptively changing one or more weights used for beamforming. The one or more weights may be changed based at least in part on an instantaneous channel condition to achieve an improved RSRP. For example, a first set of beamforming weights may achieve a first RSRP. The first set of beamforming weights may be adaptively changed to obtain a second set of beamforming weights based at least in part on the instantaneous channel condition. The second set of beamforming weights may achieve a second RSRP, where the second RSRP may be better than the first RSRP.

Legacy static beams for a CPE may be configured offline with 4 levels and a total of 242 vertical and horizontal pairs. Static beams may not be optimal while matching with 64-element antenna channels. Static beams may also be unable to adapt to multi-cluster channels and environment changes.

Dynamic beams may be employed for UEs. Dynamic beams may also be employed for CPEs. However, a dynamic beams design that is applied for UEs may not be suitable for CPEs. For CPEs, a per-element sensing for 64-element beams may not be feasible, which may be due to a single-element gain being relatively small and a CIR changing across SSBs. Although per-element sensing may be available, processing a size-64 channel matrix may be overly complex and power consuming. For CPEs, a 64-element channel estimation may be resource intensive in processing and take an inordinate amount of time, which may prevent a dynamic beams design for CPEs that is directly from channel information.

In various aspects of techniques and apparatuses described herein, a CPE may obtain, from a UE, CIR measurements associated with a set of UE beams. The set of UE beams may include strong UE beams, where the strong UE beams may be beams associated with highest RSRP measurements among a plurality of beams associated with the UE. The CPE may generate a beam correlation matrix based at least in part on the CIR measurements. The beam correlation matrix may be based at least in part on a correlation function and a quantity associated with the set of UE beams. The CPE may calculate a beam distribution vector based at least in part on the beam correlation matrix. For example, the CPE may calculate the beam distribution vector based at least in part on an eigenvalue decomposition or another suitable technique. The CPE may generate dynamic beams based at least in part on the beam distribution vector. The dynamic beams may be associated with one or more beamforming weights. The dynamic beams may allow for the one or more beamforming weights to be adaptively changed based at least in part on an instantaneous channel associated with the CPE. The CPE may communicate with the UE and/or a network node based at least in part on the dynamic beams.

In some aspects, by enabling the CPE to generate the dynamic beams based at least in part on the set of UE beams, the CPE may be able to achieve dynamic beams with a reduced amount of processing and in a reduced amount of time. The CPE may utilize the dynamic beams instead of legacy static beams, which may be unable to adapt to multi-cluster channels and environment changes. By utilizing the set of UE beams to obtain the dynamic beams for the CPE, the CPE may avoid per-element sensing for a relatively large number of beams (e.g., per-element sensing for a 64-element beam), which may reduce complexity at the CPE. The CPE may utilize the set of UE beams to obtain the dynamic beams, which may be a different dynamic beams generation scheme than that used by the UE, based at least in part on different challenges specific to the CPE versus the UE. The CPE may utilize the dynamic beams to adaptively change weights used for beamforming based at least in part on an instantaneous channel to achieve an improved RSRP, thereby improving an overall system performance.

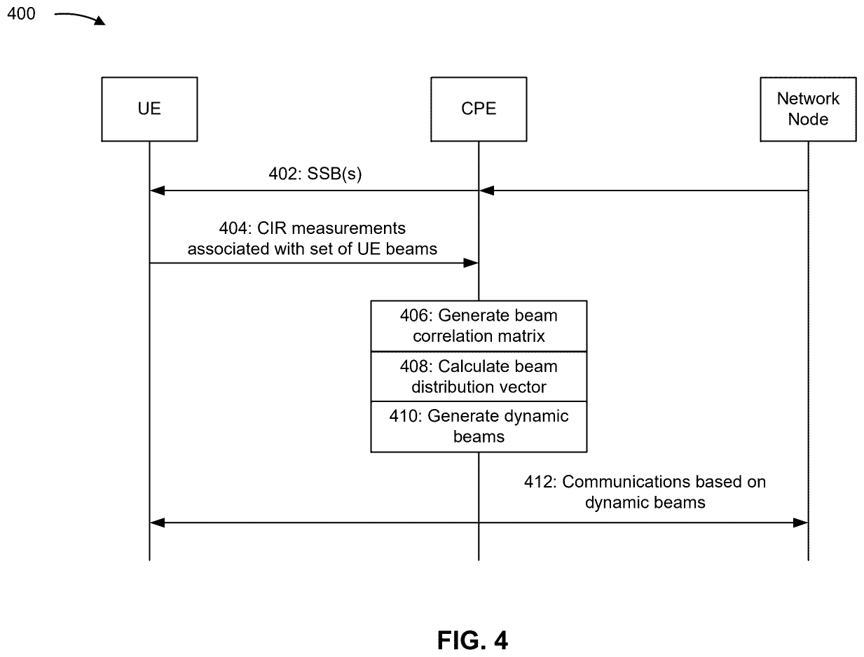

FIG. 4 is a diagram illustrating an example 400 associated with dynamic beams for a CPE, in accordance with the present disclosure. As shown in FIG. 4, example 400 includes communication between a CPE (e.g., CPE 122), a UE (e.g., UE 120), and a network node (e.g., network node 110). In some aspects, the CPE, the UE, and the network node may be included in a wireless network, such as wireless network 100.

As shown by reference number 402, the network node may transmit a plurality of SSBs, which may be based at least in part on a beam sweeping. Alternatively, or additionally, the network node may transmit a plurality of CSI-RSs. The UE may receive the plurality of SSBs (or the CSI-RSs) via the CPE. The UE may obtain RSRP measurements associated with the plurality of SSBs. The UE may identify a set of UE beams based at least in part on the RSRP measurements. The set of UE beams may correspond to strong UE beams, where the strong UE beams may be associated with highest RSRP measurements among the plurality of SSBs. In other words, the UE may perform a best beam selection, which may be based at least in part on the RSRP measurements.

As shown by reference number 404, the CPE may obtain CIR measurements associated with the set of UE beams. For example, the CPE may receive the CIR measurements associated with the set of UE beams from the UE. The set of UE beams may include the strong UE beams, where the strong UE beams may be based at least in part on predetermined UE sensing beams. The CIR measurements may be based at least in part on the plurality of SSBs. The CIR measurements may also be based at least in part on a PBCH DMRS based beam management, which may be employed at the UE. In some aspects, the set of UE beams may be based at least in part on a best single beam combination. The best single beam combination may be based at least in part on a top number of static UE beams with highest measurements among a plurality of static UE beams. In some aspects, the set of UE beams may be based at least in part on a best zone beam combination. The best zone beam combination may be based at least in part on a number of best static UE beams for a number of zones, where a plurality of antenna elements may be sectored into the number of zones.

In some aspects, a strong UE beams selection may be based at least in part on a best single beam combination. The best single beam combination may directly use a top N static UE beams with highest RSRPs as strong UE beams for sensing. The UE may be associated with a plurality of static beams, where each static beam may be associated with an RSRP measurement. The top N static UE beams, which may correspond to static beams having the highest RSRP measurements among the plurality of static beams, may be identified. For example, a best beam 1, a best beam 2, and up to a best beam N may be identified, and CIR measurements associated with the top N static UE beams may be obtained by the CPE. For example, CIR Ψ₁ (associated with best beam 1), CIR Ψ₂ (associated with best beam 2), and up to CIR Ψ_{N} (associated with best beam N) may be obtained by the CPE. From CIR measurements associated with the top N static UE beams, the correlation matrix may be generated by the CPE.

In some aspects, the strong UE beams selection may be based at least in part on a best zone beam combination. A plurality of antenna elements (e.g., of the UE) may be sectored into a number of zones, where each zone may include a subset of the antenna elements. A best static beam in each zone may be determined, and CIR measurements associated with best static beams may be obtained by the CPE. For example, 64 antenna elements may be sectored into N zones with

$$\frac{64}{N}$$

elements in each zone. The best

$$\frac{64}{N}$$

elements static beam in each zone may be determined, and a sensing for the best beam in each zone may performed using one or more SSBs. The CIR measurements may include CIR Ψ₁, CIR Ψ₂, and up to CIR Ψ_{N}, which may correspond to the best beams for the number of zones. When 64 antenna elements are selected into 4 zones, 4 CIR measurements corresponding to 4 best beams may be obtained by the CPE.

As shown by reference number 406, the CPE may generate a beam correlation matrix based at least in part on the CIR measurements. The beam correlation matrix may be based at least in part on a correlation function and a quantity (N) associated with the set of UE beams. For example, the CPE may generate an N×N beam correlation matrix R, where N is a number of strong UE beams. The CPE may generate the beam correlation matrix R as Rₘₙ=Corr(Ψₘ,Ψₙ), where Rₘₙ is an m-th row and n-th column of an R matrix, Ψₙ is a 1×128 CIR measurement of an nth sensing beam, and Corr(a, b) is the correlation function between vectors a and b.

As shown by reference number 408, the CPE may calculate a beam distribution vector based at least in part on the beam correlation matrix. The CPE may calculate the beam distribution vector based at least in part on an eigenvalue decomposition. Alternatively, the CPE may use another suitable technique for calculating the beam distribution vector from the beam correlation matrix. For example, the CPE may calculate an optimal beam distribution vector based at least in part on the beam correlation matrix R. The CPE may calculate the optimal beam distribution vector using the eigenvalue decomposition.

As shown by reference number 410, the CPE may generate dynamic beams for the CPE based at least in part on the beam distribution vector, where the dynamic beams may be associated with one or more beamforming weights. The CPE may generate the dynamic beams based at least in part on an eigenvector for a largest eigenvalue of the beam correlation matrix to maximize a CIR. The CPE may generate the dynamic beams based at least in part on a quantization of a phase and a quantization of a magnitude. The dynamic beams may be associated with two polarizations of an antenna subarray. The dynamic beams may be based at least in part on the set of UE beams, where the dynamic beams may adaptively change the one or more beamforming weights to adapt to a channel associated with the CPE

In some aspects, in order to generate the dynamic beams for the CPE, the CPE may select a combination of strong static UE beams. A strong static UE beams combination may be selected based at least in part on a CIR measurement of predetermined sensing beams (e.g., strong UE beams). In other words, a selection of the strong static UE beams combination may only require the CIR measurement of the predetermined sensing beams. The CPE may obtain the CIR measurement of N strong UE beams, where N is a positive integer. The CPE may generate the N×N beam correlation matrix R as Rₘₙ=Corr(Ψₘ,Ψₙ), where Rₘₙ is the m-th row and n-th column of the R matrix, Ψₙ is the 1×128 CIR measurement of the nth sensing beam, and Corr(a, b) is the correlation function between vectors a and b.

In some aspects, the CPE may calculate the optimal beam distribution vector based at least in part on the beam correlation matrix R. The CPE may calculate the optimal beam distribution vector using the eigenvalue decomposition, in accordance with:

$$R = Q Λ {Q}^{- 1}$$

Θₓ=[Q_{1,1} Q_{2,1} . . . . Q_{x,1}] (eigenvector for a largest eigenvalue), where Q represents an orthogonal matrix Λ represents a diagonal matrix, and Θₓ represents the optimal beam distribution vector. The CPE may generate the dynamic beams by using an eigenvector for a largest eigenvalue of the beam correlation matrix R to maximize a CIR, in accordance with:

$${W}_{DYB} = {Θ}_{x} [ \begin{matrix}{W}_{1} \\ ⋮ \\ {W}_{x}\end{matrix} ] ,$$

where W_{DYB} represents the dynamic beams, W₁ is a best beam 1 beam weight, and Wₓ is a best beam x beam weight. The CPE may further apply a proper quantization of a phase and a magnitude to satisfy a phase and magnitude constraint. As a result, the CPE may obtain dynamic beams for both polarizations of a subarray, which may have a better phase alignment to adapt to instantaneous 64-element channels. The CPE may obtain a higher RSRP as compared to using predesigned static beams.

In some aspects, for a 3 strong UE beams combination, a CIR-based technique may involve measuring CIRs for all 3 predetermined sensing beams using one SSB by using a PBCH DMRS based beam management. In other words, 3 beams may be measured on each SSB. For a 64-element channel estimation, 22 SSBs may be needed, which may be relatively slow. The 64-element channel estimation may suffer from a tracking loss due to channel changes in fading cases.

In some aspects, for a generation of dynamic beams for the CPE, a best UE beam detection may involve a beam sweeping and a best beam selection. The best beam selection may be based at least in part on one or more RSRP measurements. The dynamic beams may be based at least in part on a best beam sensing and a best beam combination (e.g., the strong UE beams combination). In some aspects, as an optimal dynamic beams implementation, the CPE may perform a dynamic beams testing, which may involve verifying RSRP measurements of different beams. A dynamic beams selection may be based at least in part on the dynamic beams testing.

In some aspects, the CPE may employ dynamic beams based at least in part on the best single beam combination or the best zone beam combination, which may achieve a higher signal-to-interference-plus-noise ratio (SINR) gain (in decibels (dB)) as compared to a best static beam of the CPE. For example, a best single beam combination with 3 zones, a best single beam combination with 6 zones, a best zone beam combination with 3 zones, and a best zone beam combination with 6 zones may all achieve a higher SINR gain (in dB) as compared to the best static beam.

In some aspects, the CPE may use the strong UE beams combination to generate the dynamic beams for the CPE, which may allow the CPE to adaptively change beamforming weights to better adapt to the channel and obtain a better RSRP, as compared to static beams associated with the CPE. One SSB may be utilized to generate the correlation matrix R of the top 3 strong UE beams for the dynamic beams generation. The CPE, by having an ability to utilize the dynamic beams, may achieve a higher throughput in both a line-of-sight (LOS) scenario and a non-line-of-sight (NLOS) scenario. For example, in the NLOS scenario, the CPE may achieve up to 2 dB of signal-to-noise ratio (SNR) gain.

In some aspects, the CPE may produce a radiation pattern that is based at least in part on generated dynamic beams in an NLOS environment (e.g., a rich-scattered environment). The radiation pattern of dynamic beams generated with multi-clusters may be irregular, as compared to a radiation pattern of static beams which may be generated in a regular manner with a single lobe. In other words, the CPE may produce an irregular radiation pattern, which may be indicative that the CPE is generating the dynamic beams using the strong UE beams combination.

As shown by reference number 412, the CPE may communicate with the UE and/or the network node based at least in part on the dynamic beams, where the dynamic beams for the CPE may be derived based at least in part on the CIR measurements associated with the strong UE beams. The dynamic beams may allow the CPE to adaptively change one or more weights used for beamforming. The CPE may adaptively change the one or more weights used for beamforming based at least in part on an instantaneous channel associated with the CPE. By allowing the CPE to adaptively change the one or more weights used for beamforming, the CPE may achieve better RSRP measurements, thereby improving an overall system performance.

As indicated above, FIG. 4 is provided as an example. Other examples may differ from what is described with regard to FIG. 4.

FIG. 5 is a diagram illustrating an example process 500 performed, for example, at a CPE or an apparatus of a CPE. Example process 500 is an example where the apparatus or the CPE (e.g., CPE 122) performs operations associated with dynamic beams for a CPE.

As shown in FIG. 5, in some aspects, process 500 may include receiving CIR measurements associated with a set of UE beams (block 510). For example, the CPE (e.g., using reception component 602 or communication manager 606, depicted in FIG. 6) may receive CIR measurements associated with a set of UE beams, as described above.

As further shown in FIG. 5, in some aspects, process 500 may include generating a beam correlation matrix based at least in part on the CIR measurements (block 520). For example, the CPE (e.g., using communication manager 606, depicted in FIG. 6) may generate a beam correlation matrix based at least in part on the CIR measurements, as described above.

As further shown in FIG. 5, in some aspects, process 500 may include calculating a beam distribution vector based at least in part on the beam correlation matrix (block 530). For example, the CPE (e.g., using communication manager 606, depicted in FIG. 6) may calculate a beam distribution vector based at least in part on the beam correlation matrix, as described above.

As further shown in FIG. 5, in some aspects, process 500 may include generating dynamic beams for the CPE based at least in part on the beam distribution vector, wherein the dynamic beams are associated with one or more beamforming weights (block 540). For example, the CPE (e.g., using communication manager 606, depicted in FIG. 6) may generate dynamic beams for the CPE based at least in part on the beam distribution vector, wherein the dynamic beams are associated with one or more beamforming weights, as described above.

As further shown in FIG. 5, in some aspects, process 500 may include communicating with a network node based at least in part on the dynamic beams (block 550). For example, the CPE (e.g., using reception component 602, transmission component 604, or communication manager 606, depicted in FIG. 6) may communicate with a network node based at least in part on the dynamic beams, as described above.

Process 500 may include additional aspects, such as any single aspect or any combination of aspects described below or in connection with one or more other processes described elsewhere herein.

In a first aspect, the set of UE beams includes strong UE beams that are based at least in part on predetermined sensing beams.

In a second aspect, alone or in combination with the first aspect, the beam correlation matrix is based at least in part on a correlation function and a quantity associated with the set of UE beams.

In a third aspect, alone or in combination with one or more of the first and second aspects, process 500 includes calculating the beam distribution vector based at least in part on an eigenvalue decomposition.

In a fourth aspect, alone or in combination with one or more of the first through third aspects, process 500 includes generating the dynamic beams based at least in part on an eigenvector for a largest eigenvalue of the beam correlation matrix to maximize a CIR.

In a fifth aspect, alone or in combination with one or more of the first through fourth aspects, process 500 includes generating the dynamic beams based at least in part on a quantization of a phase and a quantization of a magnitude.

In a sixth aspect, alone or in combination with one or more of the first through fifth aspects, the dynamic beams are associated with two polarizations of an antenna subarray.

In a seventh aspect, alone or in combination with one or more of the first through sixth aspects, the CIR measurements are based at least in part on one or more SSBs, and the CIR measurements are based at least in part on a PBCH DMRS based beam management.

In an eighth aspect, alone or in combination with one or more of the first through seventh aspects, the set of UE beams is based at least in part on a best single beam combination, and the best single beam combination is based at least in part on a top number of static UE beams with highest measurements among a plurality of static UE beams.

In a ninth aspect, alone or in combination with one or more of the first through eighth aspects, the set of UE beams is based at least in part on a best zone beam combination, and the best zone beam combination is based at least in part on a number of best static UE beams for a number of zones, where a plurality of antenna elements are sectored into the number of zones.

In a tenth aspect, alone or in combination with one or more of the first through ninth aspects, the dynamic beams are based at least in part on the set of UE beams, and the dynamic beams adaptively change the one or more beamforming weights to adapt to a channel associated with the CPE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a CPE, or a CPE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 or the communication manager 155 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 or the processing system 145 described in connection with FIG. 1) of the CPE.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 or one or more components shown in FIG. 6 may include one or more components of the CPE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the CPE described above in connection with FIG. 1, such as a radio, one or more RF chains, one or more transceivers, or one or more modems, each of which may in turn be coupled with one or more antennas of the CPE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the CPE described above in connection with FIG. 1, such as a radio, one or more RF chains, one or more transceivers, or one or more modems, each of which may in turn be coupled with one or more antennas of the CPE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The reception component 602 may receive CIR measurements associated with a set of UE beams. The communication manager 606 may generate a beam correlation matrix based at least in part on the CIR measurements. The communication manager 606 may calculate a beam distribution vector based at least in part on the beam correlation matrix. The communication manager 606 may generate dynamic beams for the CPE based at least in part on the beam distribution vector, wherein the dynamic beams are associated with one or more beamforming weights. The reception component 602 or the transmission component 604 may communicate with a network node based at least in part on the dynamic beams.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a customer premises equipment (CPE), comprising: receiving, by the CPE, channel impulse response (CIR) measurements associated with a set of user equipment (UE) beams; generating, by the CPE, a beam correlation matrix based at least in part on the CIR measurements; calculating, by the CPE, a beam distribution vector based at least in part on the beam correlation matrix; generating, by the CPE, dynamic beams for the CPE based at least in part on the beam distribution vector, wherein the dynamic beams are associated with one or more beamforming weights; and communicating, by the CPE, with a network node based at least in part on the dynamic beams.

Aspect 2: The method of Aspect 1, wherein the set of UE beams includes strong UE beams that are based at least in part on predetermined sensing beams.

Aspect 3: The method of any of Aspects 1-2, wherein the beam correlation matrix is based at least in part on a correlation function and a quantity associated with the set of UE beams.

Aspect 4: The method of any of Aspects 1-3, wherein calculating the beam distribution vector is based at least in part on an eigenvalue decomposition.

Aspect 5: The method of any of Aspects 1-4, wherein generating the dynamic beams is based at least in part on an eigenvector for a largest eigenvalue of the beam correlation matrix to maximize a CIR.

Aspect 6: The method of any of Aspects 1-5, wherein generating the dynamic beams is based at least in part on a quantization of a phase and a quantization of a magnitude.

Aspect 7: The method of any of Aspects 1-6, wherein the dynamic beams are associated with two polarizations of an antenna subarray.

Aspect 8: The method of any of Aspects 1-7, wherein the CIR measurements are based at least in part on one or more synchronization signal blocks (SSBs), and wherein the CIR measurements are based at least in part on a physical broadcast channel (PBCH) demodulation reference signal (DMRS) based beam management.

Aspect 9: The method of any of Aspects 1-8, wherein the set of UE beams is based at least in part on a best single beam combination, and wherein the best single beam combination is based at least in part on a top number of static UE beams with highest measurements among a plurality of static UE beams.

Aspect 10: The method of any of Aspects 1-9, wherein the set of UE beams is based at least in part on a best zone beam combination, and wherein the best zone beam combination is based at least in part on a number of best static UE beams for a number of zones, where a plurality of antenna elements are sectored into the number of zones.

Aspect 11: The method of any of Aspects 1-10, wherein the dynamic beams are based at least in part on the set of UE beams, and wherein the dynamic beams adaptively change the one or more beamforming weights to adapt to a channel associated with the CPE.

Aspect 12: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 13: An apparatus for wireless communication at a device, the apparatus comprising one or more memories and one or more processors coupled to the one or more memories, the one or more processors configured to cause the device to perform the method of one or more of Aspects 1-11.

Aspect 14: An apparatus for wireless communication, the apparatus comprising at least one means for performing the method of one or more of Aspects 1-11.

Aspect 15: A non-transitory computer-readable medium storing code for wireless communication, the code comprising instructions executable by one or more processors to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

Aspect 17: A device for wireless communication, the device comprising a processing system that includes one or more processors and one or more memories coupled with the one or more processors, the processing system configured to cause the device to perform the method of one or more of Aspects 1-11.

Aspect 18: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 19: A device comprising a processing system that includes one or more processors and one or more code-storing memories coupled with the one or more processors, the processing system configured to cause the device to perform the method of one or more of Aspects 1-11.

Aspect 20: A device comprising a processing system that includes processor circuitry and code-storing memory circuitry, the processing system configured to cause the device to perform the method of one or more of Aspects 1-11.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a customer premises equipment (CPE), comprising:
one or more memories; and
one or more processors, the one or more processors, individually or collectively and based at least in part on information stored in the one or more memories, being configured to:
receive channel impulse response (CIR) measurements associated with a set of user equipment (UE) beams;
generate a beam correlation matrix based at least in part on the CIR measurements;
calculate a beam distribution vector based at least in part on the beam correlation matrix;
generate dynamic beams for the CPE based at least in part on the beam distribution vector, wherein the dynamic beams are associated with one or more beamforming weights; and
communicate with a network node based at least in part on the dynamic beams.

2. The apparatus of claim 1, wherein the set of UE beams includes strong UE beams that are based at least in part on predetermined sensing beams.

3. The apparatus of claim 1, wherein the beam correlation matrix is based at least in part on a correlation function and a quantity associated with the set of UE beams.

4. The apparatus of claim 1, wherein the one or more processors, individually or collectively and based at least in part on information stored in the one or more memories, are further configured to:
calculate the beam distribution vector based at least in part on an eigenvalue decomposition.

5. The apparatus of claim 1, wherein the one or more processors, individually or collectively and based at least in part on information stored in the one or more memories, are further configured to:
generate the dynamic beams based at least in part on an eigenvector for a largest eigenvalue of the beam correlation matrix to maximize a CIR.

6. The apparatus of claim 1, wherein the one or more processors, individually or collectively and based at least in part on information stored in the one or more memories, are further configured to:
generate the dynamic beams based at least in part on a quantization of a phase and a quantization of a magnitude.

7. The apparatus of claim 1, wherein the dynamic beams are associated with two polarizations of an antenna subarray.

8. The apparatus of claim 1, wherein the CIR measurements are based at least in part on one or more synchronization signal blocks (SSBs), and wherein the CIR measurements are based at least in part on a physical broadcast channel (PBCH) demodulation reference signal (DMRS) based beam management.

9. The apparatus of claim 1, wherein the set of UE beams is based at least in part on a best single beam combination, and wherein the best single beam combination is based at least in part on a top number of static UE beams with highest measurements among a plurality of static UE beams.

10. The apparatus of claim 1, wherein the set of strong beams is based at least in part on a best zone beam combination, and wherein the best zone beam combination is based at least in part on a number of best static UE beams for a number of zones, where a plurality of antenna elements are sectored into the number of zones.

11. The apparatus of claim 1, wherein the dynamic beams are based at least in part on the set of strong beams, and wherein the dynamic beams adaptively change the one or more beamforming weights to adapt to a channel associated with the CPE.

12. A method of wireless communication performed by a customer premises equipment (CPE), comprising:
receiving, by the CPE, channel impulse response (CIR) measurements associated with a set of user equipment (UE) beams;
generating, by the CPE, a beam correlation matrix based at least in part on the CIR measurements;
calculating, by the CPE, a beam distribution vector based at least in part on the beam correlation matrix;
generating, by the CPE, dynamic beams for the CPE based at least in part on the beam distribution vector, wherein the dynamic beams are associated with one or more beamforming weights; and
communicating, by the CPE, with a network node based at least in part on the dynamic beams.

13. The method of claim 12, wherein the set of UE beams includes strong UE beams that are based at least in part on predetermined sensing beams.

14. The method of claim 12, wherein the beam correlation matrix is based at least in part on a correlation function and a quantity associated with the set of UE beams.

15. The method of claim 12, wherein:
calculating the beam distribution vector is based at least in part on an eigenvalue decomposition;
generating the dynamic beams is based at least in part on an eigenvector for a largest eigenvalue of the beam correlation matrix to maximize a CIR; and
generating the dynamic beams is based at least in part on a quantization of a phase and a quantization of a magnitude.

16. The method of claim 12, wherein the CIR measurements are based at least in part on one or more synchronization signal blocks (SSBs), and wherein the CIR measurements are based at least in part on a physical broadcast channel (PBCH) demodulation reference signal (DMRS) based beam management.

17. The method of claim 12, wherein the set of UE beams is based at least in part on a best single beam combination, and wherein the best single beam combination is based at least in part on a top number of static UE beams with highest measurements among a plurality of static UE beams.

18. The method of claim 12, wherein the set of UE beams is based at least in part on a best zone beam combination, and wherein the best zone beam combination is based at least in part on a number of best static UE beams for a number of zones, where a plurality of antenna elements are sectored into the number of zones.

19. The method of claim 12, wherein the dynamic beams are based at least in part on the set of UE beams, wherein the dynamic beams adaptively change the one or more beamforming weights to adapt to a channel associated with the CPE, and wherein the dynamic beams are associated with two polarizations of an antenna subarray.

20. A non-transitory computer-readable medium storing a set of instructions for wireless communication, the set of instructions comprising:
one or more instructions that, when executed by one or more processors of a customer premises equipment (CPE), cause the CPE to:
receive channel impulse response (CIR) measurements associated with a set of user equipment (UE) beams;
generate a beam correlation matrix based at least in part on the CIR measurements;
calculate a beam distribution vector based at least in part on the beam correlation matrix;
generate dynamic beams for the CPE based at least in part on the beam distribution vector, wherein the dynamic beams are associated with one or more beamforming weights; and
communicate with a network node based at least in part on the dynamic beams.
